(19) United States
(12) Patent Application Publication
(10) Pub. No.: US 2024/0385129 A1
(43) Pub. Date: Nov. 21, 2024

(54) AN X-RAY FLUORESCENCE SYSTEM

(71) Applicant: Commonwealth Scientific and Industrial Research Organisation, Acton, Australian Capital Territory (AU)

(72) Inventors: Brianna Ganly, Acton (AU); James Tickner, Acton (AU)

(21) Appl. No.: 18/693,902

(22) PCT Filed: Sep. 20, 2022
(86) PCT No.: PCT/AU2022/051132

§ 371 Date: Mar. 20, 2024

(30) Foreign Application Priority Data
Sep. 24, 2021 (AU) 2021903067

(51) Int. Cl. G01N 23/2206; G01N 23/223

(52) U.S. Cl. CPC G01N 23/2206; G01N 23/223; G01N 2223/076; G01N 2223/635

(57) ABSTRACT

The application discloses an X-ray fluorescence system comprising an X-ray source to emit X-ray radiation incident on the sample and a controller to vary an energy of the X-ray radiation incident on the sample between at least a first incident radiation energy and a second incident radiation energy. The system further comprises an X-ray fluorescence detector to detect X-ray radiation fluoresced by the sample in response to the incident X-ray radiation and determine at least: a first fluorescence radiation intensity of X-ray radiation fluoresced by the sample in response to the X-ray radiation incident on the sample at the first incident energy and a second fluorescence radiation intensity of X-ray fluorescence radiation fluoresced by the sample in response to the X-ray radiation incident on the sample at the second incident energy. A method of X-ray fluorescence is also disclosed.

This application claims priority from Australian provisional patent application No. 2021903067 filed on 24 Sep. 2021, the disclosure of which is incorporated herein by reference in its entirety.

### TECHNICAL FIELD

The present disclosure relates to a X-ray fluorescence system, device, or a method of use thereof. The systems, devices, and methods in which X-ray fluorescence may be used for characterising a sample. For example, X-ray fluorescence may be used to determine a material composition of a mixture, such as mixture of dry powders or a slurry.

### BACKGROUND

There exist a number of situations where characterisation of a sample comprising a mixture of materials is of value, or even required. It may be desired to characterise a composition of the sample, such as to identify one or more materials therein, and/or to identify concentration(s) of the identified material(s). For example, on-stream analysis of elements within a sample may be of value for minerals process monitoring, mining and exploration. Portable, in-field analysis of mineral and/or environmental samples may also be of value.

However, some mixtures such as dry powders and slurries may not be easily characterised. A sample may exhibit a ‘particle size effect’, wherein a characterisation of the composition of the sample may be affected by a particle size distribution of particles within the sample. A particle size effect may be a dominant source of error in measurement in some cases, potentially significantly affecting a result. While in some cases a sample can be processed, ground or fused to remove or reduce particle size effects, in other cases this may not be possible or feasible, forcing the characterisation of the composition of the sample to account for particle size effects.

Some existing systems have used X-ray based technology to carry out characterisation of samples, including X-ray fluorescence spectrometry technology ('XRF', or ‘XRF spectrometry’ hereafter). XRF spectrometry is a technique that uses incident X-ray radiation to excite a target (e.g. sample to be characterised) so that a resulting fluorescence radiation is measured to determine an elemental composition of the sample. In XRF spectrometry, the intensity of the detected radiation from the sample, and the component of this intensity from any given element of the sample, is a function of the different types of elements present in the sample. In some cases, the resulting fluorescence radiation from different elements may also be a function of their respective particle sizes.

However, existing systems can suffer from one or more shortcomings, such as size, complexity, performance, accuracy and/or cost.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

### SUMMARY

One aspect of the present disclosure relates to an X-ray fluorescence system. The system comprises an X-ray source adapted to emit X-ray radiation that is incident on the sample, a controller associated with the X-ray source, the controller adapted to vary an energy of the X-ray radiation that is incident on the sample between at least a first incident radiation energy and a second incident radiation energy, the second incident radiation energy being higher than the first incident radiation energy, and an X-ray fluorescence detector to detect X-ray radiation fluoresced by the sample in response to the X-ray radiation that is incident on the sample and determine at least a first fluorescence radiation intensity of X-ray radiation fluoresced by the sample in response to the X-ray radiation incident on the sample at the first incident energy, and a second fluorescence radiation intensity of X-ray fluorescence radiation fluoresced by the sample in response to the X-ray radiation incident on the sample at the second incident energy. The system is further configured to determine a particle size correction factor based on the first fluorescence radiation intensity and the second fluorescence radiation intensity. In some examples, the system may be used for determining the material composition of a sample containing particles of different sizes. For instance, in some examples, the system may be used to determine the amount or concentration of one or more materials of interest, such as but not limited to metals of metal compounds, in the sample.

One aspect of the present disclosure relates to a method of X-ray fluorescence. The method comprises emitting X-ray radiation from an X-ray source such that it is incident on the sample which may contain particles of different sizes, varying an energy of the X-ray radiation that is incident on the sample between at least a first incident radiation energy and a second incident radiation energy, the second incident radiation energy being higher than the first incident radiation energy; and detecting at least a first fluorescence radiation intensity of X-ray radiation fluoresced by the sample in response to X-ray radiation incident on the sample at the first incident radiation energy, and a second fluorescence radiation intensity of X-ray fluorescence radiation fluoresced by the sample in response to X-ray radiation incident on the sample at the second incident radiation energy. The method further determines a particle size correction factor based on the first fluorescence radiation intensity and the second fluorescence radiation intensity. In some examples, the above method may be used to determine a material composition of a sample.

One aspect of the present disclosure relates to use of X-ray fluorescence (XRF) to determine an element composition of a sample (e.g. of slurries or dry powders), using XRF spectrometry.

In XRF spectrometry, a magnitude of particle size effect varies as a function of exciting radiation energies. More specifically, the particle size effect decreases with increasing energy of the exciting radiation.

The present disclosure contemplates an XRF system wherein a sample is excited at different incident radiation energies (or incident energies) and a corresponding fluorescence radiation response from the sample for each of the plurality of incident energies, is measured. The fluorescence radiation response may be measured as one or more fluorescence radiation intensities at one or more corresponding fluorescence energies. The present disclosure contemplates correcting for the particle size effect based on the fluorescence radiation response for different incident energies.

Throughout the present disclosure, an X-ray radiation that the sample is exposed to may be referred to as an ‘incident’ radiation or an ‘exciting’ radiation. A resulting emitted X-ray radiation from the sample may be referred to as the ‘response’ radiation or ‘fluorescence’ radiation. Any radiation may be characterised based on its spectral content, such as by energy and/or intensity. For example, a radiation may be characterised by one or more intensities at one or more of its energies, such as its peaks or energies of interest corresponding to elements of interest.

Systems and methods of the present disclosure may be used to excite a sample over multiple instances, wherein at each instance, the sample is excited at different incident energies and, for each incident energy, a corresponding fluorescence radiation intensity is determined (e.g. directly measured). The determined fluorescence radiation intensity (or intensities, e.g. for a plurality of energies of interest) may be used to determine a particle size effect and/or an element composition of the sample. For example, a change in the determined fluorescence radiation intensity may be used to determine the particle size effect and/or the element composition, as will be described in further detail elsewhere in the present document.

An XRF system according to one embodiment of the present disclosure comprises an X-ray source, a controller for varying a radiation energy incident on the sample, and an XRF detector for detecting a fluorescence radiation intensity from the sample. The controller may vary the incident radiation energy by varying the X-ray source, e.g. by controlling settings of the X-ray source, or by varying an output from the X-ray source, e.g. by optically filtering the output from the X-ray source. In some examples, the incident X-ray radiation energy may be varied so that it jumps directly from the first incident energy to the second incident energy, e.g. by applying a filter or a step-change in the control settings.

The XRF system may further comprise a processor for determining a particle size correction factor based on the detected fluorescence radiation intensity in response to the exciting energy incident on the sample, such as from a plurality of measurements thereof. The processor may also determine a material composition based on the detected fluorescence radiation intensity/intensities and the particle size correction factor(s).

The processor may carry out one or more such determinations based on a model of correction factors, which may be predetermined. The model may take a form of one or more look-up tables, one or more transform equations, or a combination thereof. One or more of the predetermined correction models may be arrived at by one or more analytical or statistical methods.

Throughout this specification the words “comprise”, “include” and “have”, and variations such as “comprises”, “comprising”, “includes”, “including”, “has” and “having”, will be understood to imply the inclusion of a stated element, integer or step, or group of elements, integers or steps, but not the exclusion of any other element, integer or step, or group of elements, integers or steps.

### BRIEF DESCRIPTION OF DRAWINGS

By way of example only, embodiments of the present disclosure are now described with reference to the Figures in which:

FIG. 1a shows an XRF system according to an embodiment of the present disclosure;

FIG. 1b shows an example of spectrum of fluorescent radiation intensity against fluorescent radiation energy for XRF.

FIG. 2a shows an X-ray source and a set of rotatable filters, in a first position, according to an embodiment of the present disclosure.

FIG. 2b shows the X-ray source and the set of rotatable features of FIG. 2a in a different position.

FIG. 3a shows an X-ray source and a set of linearly movable filters, in a first position, according to another embodiment of the present disclosure.

FIG. 3b shows the X-ray source and the set of linearly movable features of FIG. 3a in a different position.

FIG. 4 shows an example schematic of an XRF system according to an embodiment of the present disclosure.

FIG. 5 shows a plot of a ratio of fluorescence mass attenuation coefficient to exciting radiation mass attenuation coefficient as a function of exciting X-ray radiation energy, for four different elements, calculated with a concentration of 3% in an organic matrix.

FIG. 6 shows a plot of a ratio of fluorescence mass attenuation coefficient to exciting radiation mass attenuation coefficient as a function of exciting X-ray radiation energy, for copper with varying concentrations and for different matrix materials.

FIG. 7 shows a plot of particle size effects shown as relative fluorescence intensity as a function of particle size, for a 3% copper sample in water, for various exciting radiation energies.

FIG. 8 shows a filtered X-ray incident radiation energy spectrum predicted by the Ebel model for an example XRF system.

FIG. 9 shows an example particle size effect correction figure.

FIG. 10 shows a plot of X-ray fluorescence radiation intensities measured from a 3% copper sample in a dough matrix, excited with two different exciting radiation spectrum from a single X-ray tube and a zinc filter or a zirconium filter.

FIG. 11 shows a plot of X-ray fluorescence radiation intensities measured from a 5% iron sample in a dough matrix, excited with two different exciting radiation spectrum from a single X-ray tube and a zinc filter or a zirconium filter.

FIG. 12 shows an example correction figure covering a range of copper concentrations from 1-5% in a silica slurry.

FIG. 13 shows the correction figure of FIG. 12, further indicating possible ranges of I1/I1(0) based on a particular I1/I2 value.

FIG. 14a shows an example method of X-ray fluorescence according to the present disclosure.

FIG. 14b shows a method of determining a material composition of a sample according to an example of the present disclosure.

### DESCRIPTION OF EMBODIMENTS

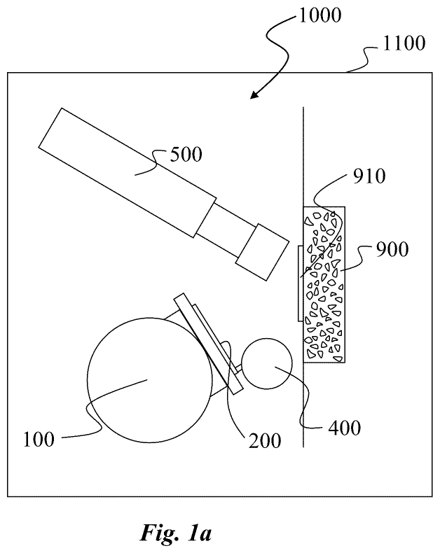

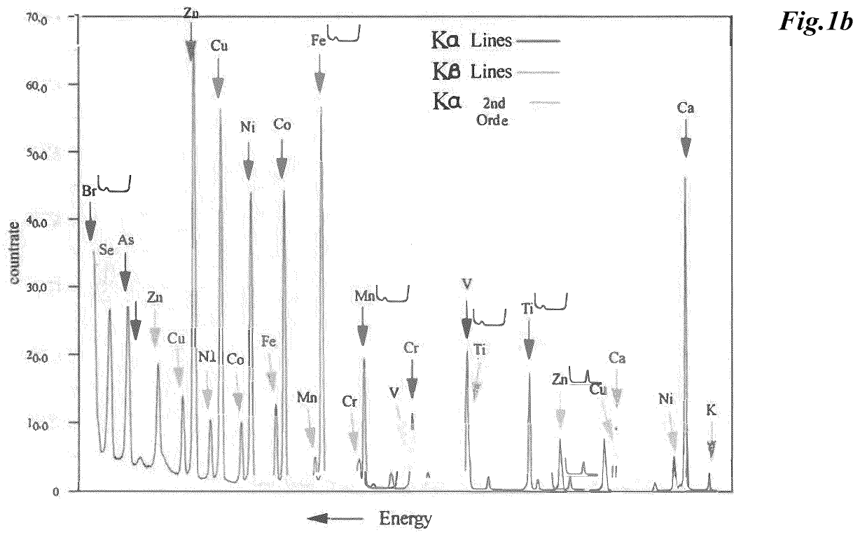

With reference to FIG. 1a, in one embodiment of the present disclosure, an XRF system 1000 is provided that comprises an X-ray source 100 (e.g. an X-ray tube) and a set of filters 200. The set of filters 200 may be configured to apply variable filtration to the raw X-ray radiation emitted from the X-ray source 100. The set of filters 200 may comprise one or more filters (e.g. one, two, three, four or more filters). Each of the one or more filters may comprise different materials to filter certain energies out of the radiation spectrum emitted from the X-ray source 100, thus varying the incident radiation energy on a sample. The X-ray source 100 may also be operable at a plurality of voltage and/or current settings to vary the incident radiation energy.

The X-ray source 100 and the set of filters 200 in FIG. 1a are configured such that the emitted X-ray radiation is incident upon the sample 900.

The XRF system 1000 may comprise a controller configured to control the set of filters 200 and/or the X-ray source 100 to adjust the incident X-ray radiation energy. The XRF system 1000 also comprises a detector 500 (e.g. an energy-resolving X-ray detector) configured to receive radiation fluoresced from the sample 900 and to determine radiation energy and/or intensity thereof.

The XRF system 1000 may comprise a sample delivery mechanism to move the sample 900 to a position in which the X-ray radiation from the X-ray source 100 falls incident on the sample 900. Thus, the XRF system 1000 may be configured to analyse a sample 900 delivered by the sample delivery mechanism. A sample delivery mechanism may be configured to transport the sample 900 to a position behind an X-ray window 910, and/or to a position on a sample bed or other platform. A sample bed or another platform may support and/or locate the sample 900 at a position in which the X-ray radiation from the X-ray source 100 falls incident on the sample 900. The sample 900 may be a liquid or slurry, a powder or dry material, or a discrete sample or particulate material, for example.

A sample delivery mechanism may be a conveyor belt or a pipe configured to receive a sample 900 from a reservoir or a store of the material to be analysed. A sample delivery mechanism may alternatively or additionally be a receptacle (e.g. a tank) including a plurality of slots for samples to be analysed. The receptacle (e.g. the tank) may be configured to stir the contents therein. A sample bed may be a container configured to be located on the sample delivery mechanism, such as to be transported along a conveyor belt or inserted into a slot in the receptacle.

A sample to be analysed may be stationary in some arrangements, although measurements may be carried out on a moving sample. A dry sample may be held stationary for example at a predetermined position as shown in FIG. 1a to be characterised by the XRF system 1000. Where the sample is a liquid or a slurry, the sample may be in motion, for example to keep the particles agitated and mixed. Due to this motion, the portion of the sample being excited by the X-ray source 100 and providing a response may change from one measurement to another. In such an arrangement, a set of measurements may be taken over a period of time to account for variations due to the movement. Throughout the specification, the term ‘sample’ may refer to both a stationary sample or a sample in motion, including arrangements wherein the portion of the sample being characterised by the XRF system 1000 may vary due to a movement of the sample.

The controller may be configured to vary settings of the X-ray source 100 and/or control the set of filters 200 applied thereto to produce a plurality of incident radiation energies. The controller may control the set of filters 200 and/or the settings of the X-ray source 100 by one or more of remote, local, wired, wireless, manual or automatic means. For example, the XRF system may comprise a motor 400 operable (e.g. by the controller) to select one of the set of filters. As another example, the controller may comprise a manual switch, button or lever that is operable to select one of the set of filters.

The XRF system 1000 may comprise a frame 1100 for locating, fixing and/or supporting one or more components of the XRF system, for example to place one or more of the X-ray source 100, set of filters 200, motor 400, detector 500 and sample 900 in predetermined position(s) with respect to each other.

The XRF system 1000 may thus be configurable to a plurality of settings to vary the incident radiation energy incident on the sample 900. As discussed in more detail below, at each of the plurality of settings/at each incident energy, a corresponding fluorescence radiation response from the sample 900 may be determined or measured.

In XRF, the X-ray source 100 delivers incident radiation to the sample 900. The incident radiation may ionize an atom in the sample by expelling an electron from the inner orbit of the atom. As a result the atom structure becomes unstable and an electron from a higher orbit may fall into the lower orbital hole left behind. In falling the electron releases energy in the form of a photon. This release of energy is referred to as fluorescence radiation. The emitted fluorescence photon has a characteristic energy equal to the difference between the energy of the initial and final electron orbital. As the emitted fluorescence photon has a characteristic energy it also has a characteristic wavelength which may be determined using Planck's Law.

A transition from an L electron shell or orbit to a K electron shell or orbit (a L→K transmission) is referred to as a Kα transition, a transition from a M electron orbit to a K electron orbit (a M→K transmission) is referred to as a transition a K_{β} transition and a transition from an M electron orbit to a L electron orbit (a M→L transmission) is referred to as a L_{α} transition. Each chemical element has electron orbitals of characteristic energies and therefore fluoresce photons of one or more characteristic energies when subjected to XRF. Therefore the type(s) of material in the sample can be determined based on the fluorescent radiation. The fluorescent radiation may be analysed by sorting the fluorescent photons either by energy (known as energy-dispersive analysis) or by wavelength (known as wavelength-dispersive analysis). The intensity (e.g. photons per second) of each characteristic energy or wavelength may be measured to create a spectrum of the fluorescent radiation from the sample. The material present in the sample may then be determined based on the fluorescent radiation spectrum. For instance, FIG. 1b shows a theoretical spectrum of fluorescent radiation intensity against fluorescent radiation energy in which the peaks correspond to different chemical elements. For a sample containing multiple materials, the spectrum may comprise several characteristic energy (or wavelength) peaks each associated with a particular material and the intensity of each characteristic energy (or wavelength) peak may be directly related to the amount of that material in the sample. Therefore the material composition of the sample may be determined based on the intensities of the fluorescent radiation at one or more fluorescence energies (or wavelengths).

XRF systems according to one or more embodiments of the present disclosure are adapted to direct at least two different incident radiation energies of X-ray onto a sample; wherein the incident radiation energy refers to the photon energy or wavelength of the X-ray incident on the sample. In XRF systems according to one or more embodiments of the present disclosure, at least one of the incident radiation energies may be chosen based on particular elements of the sample to be detected and that are of interest to the user. In one example, a first incident energy may be chosen to induce a large particle size effect for an element of interest in the sample, and particularly in relation to a corresponding first fluorescence radiation response intensity, and a second incident energy may be chosen to induce a minimal particle size effect for the element of interest in the sample, and particularly in relation to a corresponding second fluorescence radiation response intensity. Thus, each of the plurality of the settings for an XRF system may be targeted at an element of interest.

In one embodiment, a first incident energy (E1) may be chosen to be as close to, but greater than, the binding energy of the inner-shell electrons (the K-edge) of the element of interest. This induces a large particle size effect in the fluorescence radiation, which can be determined by a measurement of fluorescence radiation intensity. A second incident energy (E2) may be chosen to be significantly higher than the first incident energy E1, for example but not limited to 3 times higher (i.e. E1×3≈E2). When E2 is significantly higher than E1 the particle size effect on the fluorescence radiation intensity is minimal. In this way the first fluorescence radiation corresponding to the first incident radiation energy (E1) will exhibit a large particle size effect, while the second fluorescence radiation corresponding to the second incident radiation energy (E2) will exhibit no particle size effect or a minimal particle size effect.

In another embodiment, an XRF system may be configured for multiple elements of interest. In such a case, a first incident energy (E1) may be chosen to be as close to, while remaining greater than, the K-edge of the highest Z-element of interest. The highest Z-element of interest refers to the element of interest which has the highest atomic number, e.g. if the elements of interest are Fe (atomic number 26) and Cu (atomic number 29), then the first incident energy (E1) may be chosen to be close to, but greater than, the K-edge of Cu. The K-edge of an element refers to the binding energy of the inner shell (K-shell) electrons of the element. The K-edge is different for each element and may be found by referring to standard reference tables. A second incident energy E2 may be chosen in a similar manner as above; for instance, the second incident energy E2 may be chosen to be between 2.5 and 3.5 times E1.

In some forms, E2 values of a few keV higher than E1 to 100 keV may be still suitable. In one form, an XRF system may be configurable to a plurality of settings (e.g. for a plurality of elements), wherein a constant E2 value may be used, while each of the plurality of settings may comprise a suitable, different, E1 value.

Under some circumstances, a potential impact of Compton (inelastic) and Rayleigh (elastic) scattering of the exciting radiation energy may need to be taken into account, as they may overlap with energies of the fluorescence radiation peaks of interest. For example, exciting a sample of copper, whose XRF line appears at 8 keV in the spectrum, with a theoretical optimum E1 of 8.9 keV, may produce Compton scatter energy of around 8 keV, which would then overlap with the fluorescence radiation energy of interest. Such a result would interfere with the measurement, and in such cases an E1 energy of approximately 1-2 keV or 1-3 keV higher than the K-edge value may be chosen, such as approximately 2 keV higher than the K-edge value.

The incident radiation energy may be varied by one or more of a change of optical filtration, change of voltage, change of current, including a combination thereof.

A suitable X-ray source may be a Mo-target X-ray tube, operable at voltages between 20 to 100 kV.

One suitable set of filters may include a zinc filter, which when used with the X-ray source (e.g. a Mo-target X-ray tube) can create a radiation energy output of approximately 9.6 keV, and a tin filter, which when used with the X-ray source can create a broad radiation output peak with the greatest intensity at an energy of 29 keV. Another suitable set of filters may include one filter, such as one of the above filters, and a null filter (e.g. no filter or an X-ray transparent window). In the context of this application the expressions “null filter” is used to denote either that no filter is present or that a filter which is transparent to X-rays.

A filtration characteristic, or profile, of a filter may be affected by one or more properties of the filter, such as filter material, thickness, geometry or the like. Accordingly, a set of filters may be configured to apply variable filtration to an X-ray radiation output by comprising a plurality of filters, wherein each of the plurality of filters' characteristics vary. Thus, a first filter may be configured to vary from a second filter in one or more of the above properties. In some forms, one or more of flat crystals, HOPG crystals, optics, multi-layer optics and prism filters may be suitable to produce desired incident radiation energy characteristics. Additionally, or alternatively, one or more relationships of the filter with respect to the X-ray source, such as their relative positioning with each other, may affect the filtration characteristic or profile. For example, the system may be configured such that varying an angle between a filter and the X-ray source varies a filtration characteristic, and therefore a desired incident radiation energy characteristic. Of course, in some embodiments, the set of filters may comprise a removable filter so that one may modify the XRF system according to the needs of a particular test or sample.

A suitable controller may be a switch configured to selectively place one of the set of filters in front of the X-ray tube to change radiation energy being delivered to the sample (i.e. incident radiation energy). The set of filters may be configured to move linearly, rotationally or otherwise, to select individual filters. The controller may also directly adjust the X-ray source itself to adjust the incident radiation energy, such as by modification of a voltage and/or a current supplied to the X-ray source. The controller may also adjust the angle of a filter (e.g. a flat crystal or a multilayer optic) relative to the X-ray source 1000 to selectively filter the radiation energy.

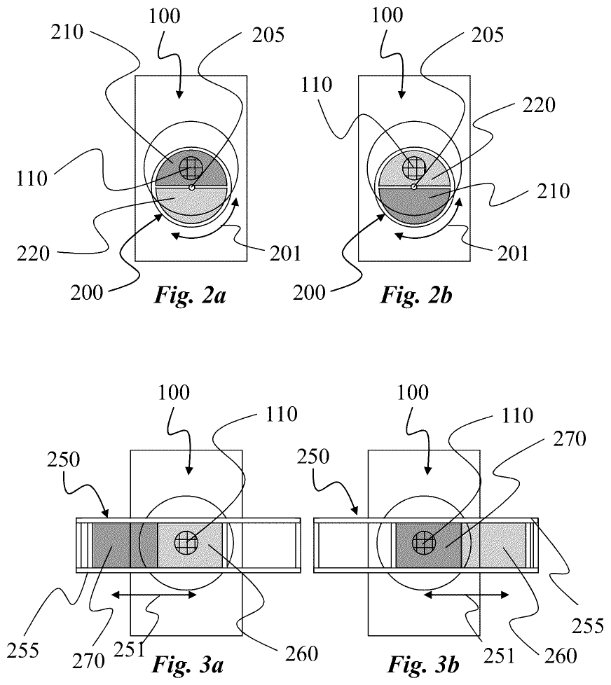

With reference to FIGS. 2a and 2b, one embodiment of the present disclosure employs a set of filters 200 including a first filter 210 and a second filter 220 arranged as a disc in front of an X-ray source 100 to adjust the incident radiation energy. The X-ray source 100 comprises an X-ray outlet (or an X-ray emission end) 110 configured to emit the X-ray radiation. The set of filters 200 is rotatable about a pivot 205 (e.g. in the direction of the arrows shown in FIGS. 2a and 2b) to selectively position either the first filter 210 or the second filter 220 in front of the X-ray outlet 110, to filter the emission from the outlet 110. In a first configuration, as shown in FIG. 2a, the first filter 210 is positioned in front of the X-ray outlet 110, and, in a second configuration, as shown in FIG. 2b, the set of filters 200 has rotated to position the second filter 220 in front of the X-ray outlet 110.

With reference to FIGS. 3a and 3b, in an alternative embodiment, a set of filters 250 is used including a first filter 260 and a second filter 270 arranged on a frame 255 in front of the X-ray source 100 to adjust the incident radiation energy. The first filter 210 and the second filter 220 are configured to be moved linearly (e.g. in the direction of the arrows 251 shown in FIGS. 3a and 3b). The set of filters 250 is slidable along the frame 255 to selectively position either the first filter 260 or the second filter 270 in front of the X-ray outlet 110, to filter the emission from the outlet 110. In a first configuration, as shown in FIG. 3a, the first filter 260 is positioned in front of the X-ray outlet 110, and, in a second configuration, as shown in FIG. 3b, the set of filters 200 has moved linearly to position the second filter 270 in front of the X-ray outlet 110.

As described elsewhere in the present disclosure, a set of filters 200 may comprise more than two filters.

Additionally or alternatively, a filter may be a null filter, which is to say that it may not have any impact on the energy of the emission delivered from the X-ray outlet 110 to the sample. Of course, it will be understood that a number of other arrangements of filters may be suitable.

As discussed above, the XRF system may be configured to excite the sample at a plurality of different incident radiation energies. An incident radiation energy may be characterised based on a single energy level (e.g. quasi-single energy peak) or may comprise a range of energy levels around a maximum intensity energy level. In the case of a range, the incident energy level may be considered to be the maxim intensity level in the range. For instance a graph of intensity against energy for the incident radiation may take the form of a narrow peak or line (quasi-single energy peak) or a broader peak centered around a maximum intensity energy level.

Each incident radiation energy will result in corresponding fluoresced radiation spectrum. The fluoresced radiation spectrum may comprise one or more peaks. Each peak may be at a characteristic energy or wavelength which is representative of a material of interest present in the sample. The fluorescent radiation intensity of each peak may be measured as fluorescence counts per second. In one example, each different incident radiation energy (e.g. first and second incident radiation energies E1 and E2), will result in a corresponding different, fluorescence radiation intensity (e.g. first and second fluorescent radiation intensities I1 and I2) from the sample. Each fluorescence radiation intensity (e.g. I1 and I2) may be at a characteristic energy or wavelength associated with a particular material of interest. For instance, I1 and I2 may be at the same energy, but differ in intensity and may be used to determine, and/or correct for the particle size effect.

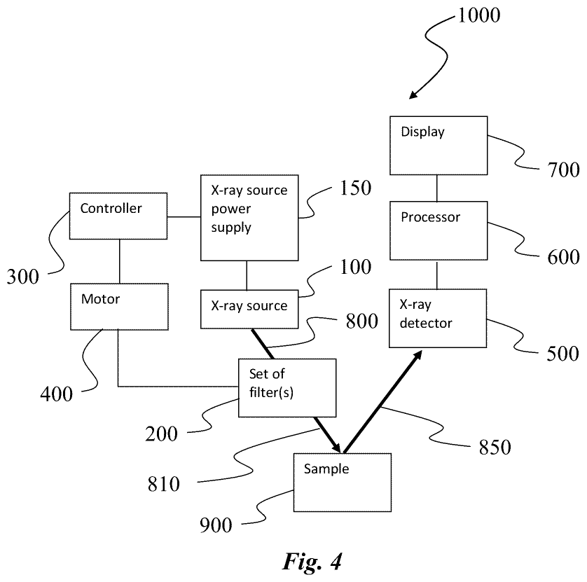

FIG. 4 shows a schematic diagram of an XRF system 1000 according to an embodiment of the present disclosure. In FIG. 4, an X-ray source 100, powered by a power supply 150, outputs a raw X-ray radiation 800. The raw X-ray radiation 800 is filtered by a set of filters 200, e.g. configured as shown in FIGS. 2a and 2b, to result in an exciting radiation 810 that is incident on the sample 900.

In this embodiment, a controller 300 is used to vary the exciting X-ray radiation 810 energy by both adjusting settings of the X-ray source power supply 150 as well as driving the motor 400 to position the set of filters 200 as desired.

The sample 900, in response to the exciting X-ray radiation energy 810, produces a fluorescence radiation 850 that is detected by the X-ray detector 500. As described above, this process can be performed at a plurality of exciting radiation 810 energies, producing a plurality of fluorescence radiation 850 intensities. One or more signals representing the fluorescence radiation 850 intensities as detected by the X-ray detector 500 is delivered to the processor 600 from the X-ray detector 500. The processor 600 can then perform a set of analyses to determine, for example, particle size effect(s) and/or element composition(s) of the sample, and output the result(s), e.g. to be shown on a display 700. An output from the processor 600 may comprise one or more of a particle size measurement, an elemental concentration or an element composition, for example.

In some embodiments, the XRF system may be configured to communicate one or more of the results in real-time, such as through the display 700.

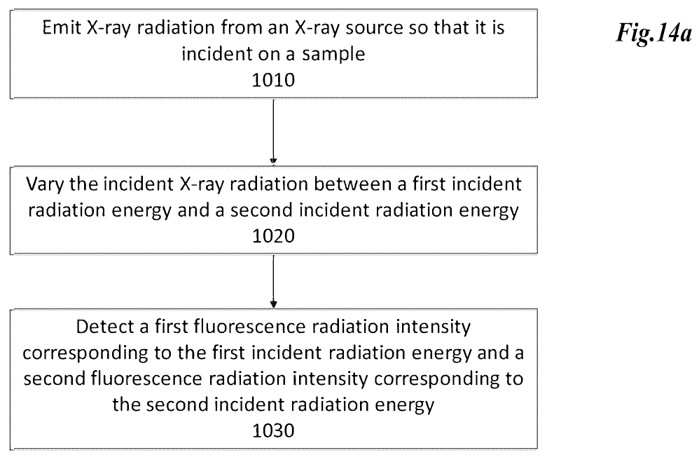

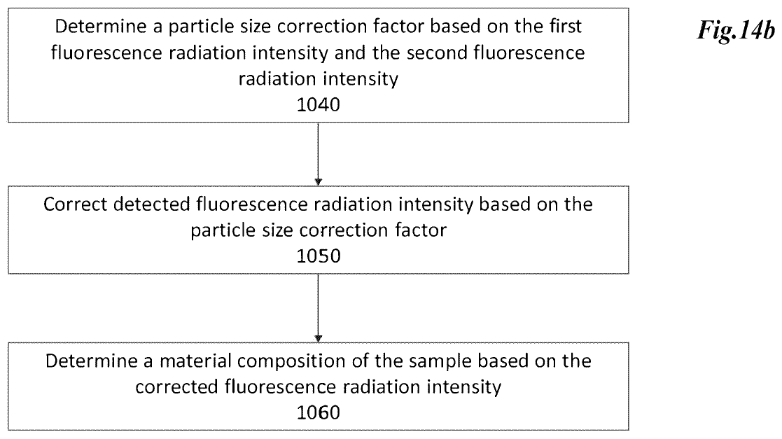

FIG. 14a shows an example method of XRF according to the present disclosure which may be performed by any of the apparatus described in FIGS. 1 to 4 for example. At block 1010 X-ray radiation is emitted from an X-ray source such that it is incident on a sample. At block 1020 the incident X-ray radiation is varied so that at least a first incident radiation energy and a second incident radiation energy (which is higher than the first incident radiation energy) are incident on the sample. For instance the incident radiation energy may be varied by use of one or more filters or by changing a current or voltage of the X-ray source. At block 1030 a first fluorescent radiation intensity corresponding to the first incident radiation energy and a second fluorescence radiation intensity corresponding to the second incident radiation energy are detected. The first and second fluorescence radiation intensities may for example be detected by a detector 500 as shown in FIGS. 1 and 4. When there is just one incident radiation energy this may be used to determine the material composition of the sample based upon the intensities and locations of the characteristic peak or peaks in the fluoresced radiation, however this is subject to error due to the particle size effect by which the intensity of fluoresced radiation varies with particle size. However, as the method of FIG. 14A obtains first and second fluorescence radiation intensities generated by different first and second incident radiation energies, this makes it possible to detect and compensate for the particle size effect. This is possible because the magnitude of the particle size effect varies depending on the incident radiation energy. This approach may help to more accurately determine the material composition of a sample.

FIGS. 14b shows an example method of correcting for the particle size effect. At block 1040 a particle size correction factor is determined based on the first fluorescence radiation intensity and the second fluorescence radiation intensity. In some examples the particle size correction factor may be determined based on the ratio of the first fluorescence radiation intensity to the second fluorescence radiation intensity. In some examples the ratio may be cross referenced with a look up table to determine an appropriate particle size correction factor. At block 1050 one or more detected fluorescence radiation intensities are corrected based on the particle size correction factor determined in block 1040. The corrected fluorescence radiation intensity(ies) may be the first fluorescence radiation intensity, the second fluorescence radiation intensity or another later fluorescence intensity detected by the X-ray detector.

At block 1060 a material composition of the sample is determined based on the corrected fluorescence radiation intensity. For example, this may be done by determining characteristic energy or energies at which the peak or peaks occur in the detected fluorescence radiation. Each characteristic energy corresponds to a particular material (e.g. element). Therefore, the material or materials present in the sample may be determined based on the characteristic energy level(s). The concentration and/or relative proportion of the material or materials may then be determined based upon the magnitude(s) of the corrected fluorescence radiation intensity(ies) of the peak(s).

For example, the corrected fluorescence radiation intensity of a peak may be compared to a predetermined calibration curve for an element having the characteristic energy of the peak. The calibration curve for each element may be established by measuring a set of standard samples (samples with a known composition and particle size) and plotting for each sample the measured fluorescence intensity for that element versus the percentage amount of that element.

Another approach for determining the materials composition from the corrected fluorescence intensities is to use the ‘Fundamental parameters’ method. The fundamental parameters method is a first-principles calculation method of chemical element concentration from the corrected fluorescence peak intensities for each element in the sample. This method uses a theoretical model in which the corrected florescence radiation intensities are mapped to concentrations of elements which would theoretically produce these intensities. The theoretical model may use fundamental physics parameters such as the X-ray absorption coefficients, fluorescence yields, jump ratios, branching ratios as well as the incident spectrum from the X-ray tube in a series of equations to determine the element concentrations in the sample.

Particle size effects reduce generally as incident radiation energy increases. However, this reduction in particle size effects generally diminishes after a particular incident radiation energy is reached. This point may be referred to as an optimum incident radiation energy, or optimum exciting energy. That is the energy is optimum as the particle size effect is reduced to a large extent without overly increasing the incident energy.

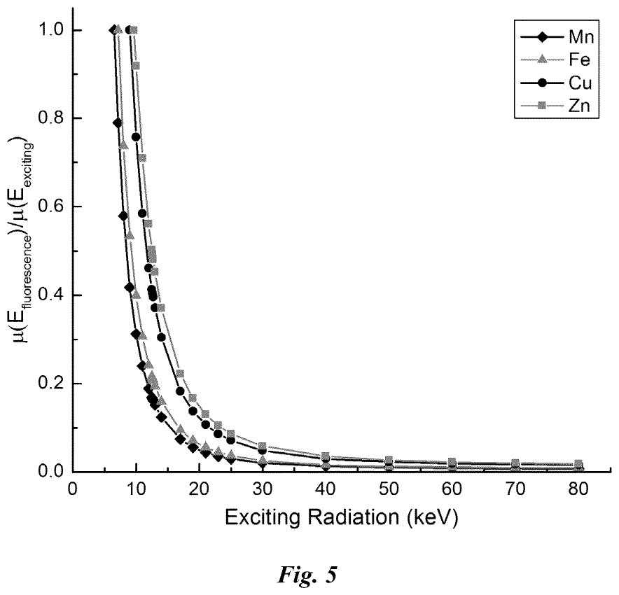

In one method according to the present disclosure, to determine the optimum exciting energy, a ratio of the fluorescence radiation mass attenuation coefficient (μ(Ε_{fluorescence})) to the exciting radiation energy mass attenuation coefficient (μ(Ε_{exciting})) (i.e. μ(Ε _{fluorescence})/μ(Ε _{exciting})) is plotted as a function of varying exciting radiation energy. An example of such a plot is provided in FIG. 5. In FIG. 5, mass attenuation coefficient ratios are plotted for four different elements (Mn, Fe, Cu and Zn), calculated with a concentration of 3% in an organic matrix. The exciting radiation mass attenuation coefficient of a material is a measure of probability of an interaction between the incident radiation and the material, while the fluorescence radiation mass attenuation coefficient is a measure of the probability of an interaction between the fluorescence radiation and the material.

FIG. 5 shows that for each element, the fluorescence mass attenuation coefficient becomes negligible compared to the exciting radiation mass attenuation coefficient (i.e., (μ(Ε_{fluorescence})/μ(Ε_{exciting}) <<1) and the curve plateaus at higher exciting radiation energies. The optimum exciting energy can be determined thus. In this example, for iron and manganese, the optimum exciting energy is determined as approximately 30 keV and for copper and zinc the optimum exciting energy is determined as approximately 40 keV.

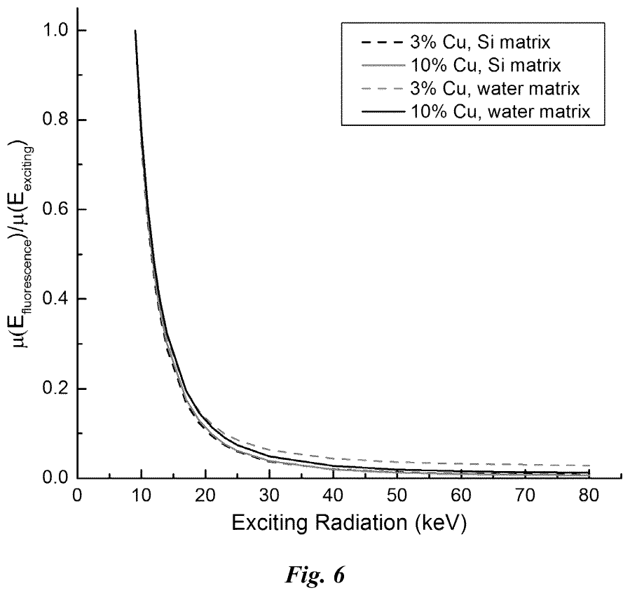

FIG. 6 shows the same trend as FIG. 5, but for one material (copper) only, at varying concentrations (3% or 10%) and for different matrix materials (Si matrix or water matrix). FIG. 6 shows that the ratio of the fluorescence radiation mass attenuation coefficient to the exciting radiation mass attenuation coefficient (μ(Ε_{fluorescence})/μ(Ε_{exciting}) is mostly independent of the sample concentration and matrix. In such a situation, a sample composition may not need to be known exactly to select the optimum exciting radiation energy, as it will remain a very similar value for changing concentrations and matrix materials.

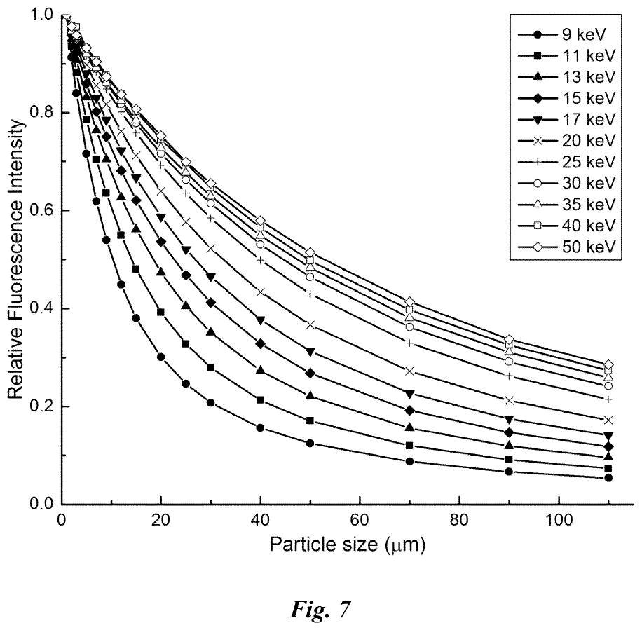

Given the above, a particle size effect may be predicted, for example by way of simulations. FIG. 7 shows a simulated plot of relative fluorescence radiation intensity of a sample containing 3% copper in water, with varying exciting radiation energy. As can be seen from FIG. 7, the changes in fluorescence radiation intensity due to the particle size effect are relatively insignificant as the excitation radiation energy is varied from 30 keV to 50 keV, in comparison to the changes that are evident when the excitation radiation energy is varied between 9 keV and 25 keV. Accordingly, this graph indicates that a value of 30 keV may be a suitable optimum exciting energy for copper.

In an alternative approach, in embodiments of the present disclosure, a predetermined ratio of fluorescence radiation mass attenuation coefficient to exciting radiation mass attenuation coefficient (μ(Ε_{fluorescence})/μ(Ε_{exciting}) may be used to determine an optimum exciting energy. For instance, a 0.05 ratio of fluorescence radiation mass attenuation coefficient to exciting radiation mass attenuation coefficient may be chosen. This is because, when the said ratio reaches 0.05, the fluorescence radiation mass attenuation coefficient is negligible compared to the exciting radiation mass attenuation coefficient.

In such an approach, the exciting radiation energy corresponding to a 0.05 ratio can be determined for each element as presented in Table 1 below. Table 1 shows for a number of elements an optimum exciting energy E1 and high exciting energy E2, where the optimum exciting energy (E1) is chosen to be just above the K-edge of each element, and the high exciting energy (E2) is chosen so that the ratio of fluorescence radiation mass attenuation coefficient to exciting radiation mass attenuation coefficient is 0.05 or less. The ratio of E1 to E2 is shown in the rightmost column. Thus, in some forms of the present disclosure, for elements with atomic numbers 25 to 30, E2 may be estimated by multiplying E1 by 3 for example.

TABLE 1

| Atomic | Element | | E2 | |
|---|---|---|---|---|
| number | symbol | E1 | μ(f)/μ(E) < 0.05 | E2/E1 |
| 25 | Mn | 6.55 | 20 | 3.053435 |
| 26 | Fe | 7.15 | 22 | 3.076923 |
| 29 | Cu | 9 | 29 | 3.222222 |
| 30 | Zn | 9.67 | 31 | 3.205791 |

It is also noted that, as the exciting radiation energy increases, the relative fluorescence response generally decreases. In other words, a desire to minimise the particle size effect should be balanced against unduly reducing the fluorescence radiation intensity (e.g. I1 and I2) from the sample. For example, the source strength between E1 and E2 may be chosen so that the fluorescence response does not vary greatly between measurements to minimise a need for any adjustments between I1 and I2. If poorly chosen, intensities I1 and 12 may differ from each other by orders of magnitude, in which case one or more settings may need to be adjusted in the detector 500 between measurements. It will be understood from the above, however, that a range of exciting energies may be suitable for the purposes of the present disclosure.

Determined optimum energies may thus define the desired, or target energies E1ₜ and E2ₜ. However, determined E1ₜ and E2, may be single energies, whereas a combination of the X-ray source and filter in reality may produce a spectrum of a range of energies. Thus, an XRF system may be configured to produce exciting radiation energies E1 and E2 with radiation spectra with maximum intensity as close to E1ₜ and E2ₜ respectively, while minimising outputs in other energy ranges. In other words, exciting radiation energies E1 and E2 may be substantially monoenergetic, for example to be within ranges of feasibilities of the equipment.

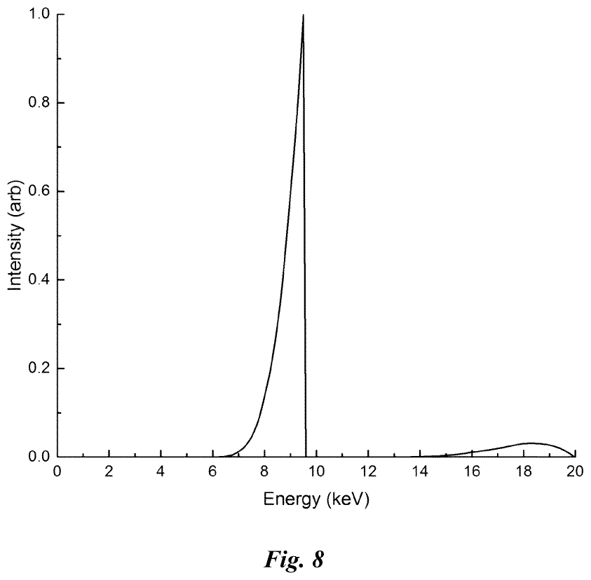

An analytical model may be used to determine an appropriate combination of X-ray source and filter. For example, an Ebel model may be used, taking into consideration an X-ray tube type, tube target, the operating settings and the filter material. The Ebel model may also predict the X-ray source strength based on the information given to the model. As an example, a target energy for the incident radiation energy E1ₜ may be approximately 10 keV, just above the copper K-edge of 8.98 keV. To obtain an exciting radiation spectrum as close as possible to this for example, a molybdenum target Oxford Instruments X-ray tube with a zinc foil filter (0.1 gm/cm²) may be appropriate, run at a voltage of 20 kV and 0.6 mA current. FIG. 8 shows the predicted output spectrum as predicted by the Ebel model, and it can be seen that the spectrum may be suitably close to the target energy E1ₜ.

Zinc may be a suitable filter material in this situation as its K-edge is 9.66 keV, and radiation immediately after the K-edge will be readily absorbed by the zinc filter, creating a pseudo-peak at approximately 9.6 keV as shown in FIG. 8.

Those skilled in the art may be able to determine appropriate combinations of X-ray sources and filters as required, such as by following similar models as above. For example, one may be able to predict suitable filters as starting points, and apply an analytical model such as the Ebel model to refine the filter material, thickness and X-ray source settings to obtain an appropriate X-ray source exciting radiation with an appropriate energy spectral density and intensity for measuring the particle size effect.

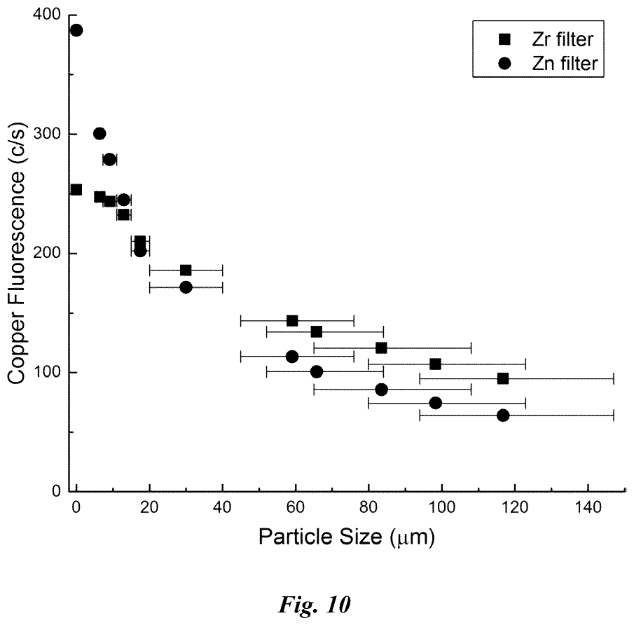

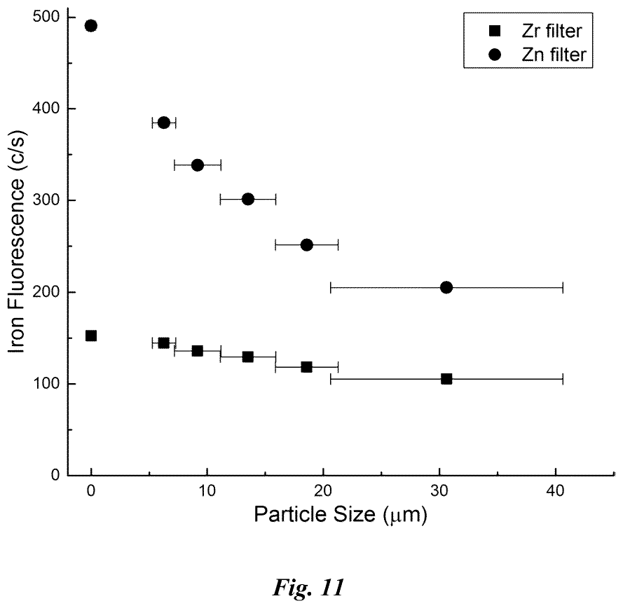

In one example according to the present disclosure, results obtained from an XRF system using two different filters (a Zr filter and a Zn filter) to selectively filter radiation from an X-ray source are presented. FIG. 10 shows measurements carried out using a 3% copper sample in a dough matrix, and FIG. 11 shows measurements carried out using a 5% iron sample in a dough matrix. The results show that particle size effects can be successfully determined using an XRF system that varies incident radiation energies according to embodiments of the present disclosure, including where a set of filters in combination with a single X-ray source is used to determine the particle size effects.

Further discussions regarding determination of particle size effects and/or element compositions follow below.

In one form, an a priori particle size effect estimate is provided to the XRF system in order to perform required corrections.

A particle size effect may be estimated based on a sample composition and exciting radiation, such as using analytical methods based on a monoenergetic exciting radiation. However, some X-ray sources, such as X-ray tubes, generate poly-energetic exciting radiation spectra. While filtration may help to produce quasi-monoenergetic exciting radiation spectra, it may be unlikely for a single X-ray source and a combination of filters to produce quasi-monoenergetic spectra. Thus, alternative techniques of particle size effect estimation may be useful under some circumstances.

In one form, a statistical method such as Monte Carlo simulations may be used to predict a particle size effect. Such simulations may be used to simulate the exciting radiation spectra from X-ray tubes, taking into account variables such as filter materials, X-ray tube voltages and current settings. The resulting distribution of particle size effects may be used to arrive at a model of particle size effect predictions.

The estimated particle size effect may be calculated for both incident radiation energies E1 and E2, as a function of particle size against fluorescence radiation, e.g. fluorescence intensity (I1 and I2) measured in counts per second by a detector, of the element of interest.

One sample correction operates as a function of a grade (i.e., quality and/or purity) of the element of interest and the measurements I1 and I2, for example taking a form of:

$$Element grade = f ( I 1 / I 2 ) \times I 1$$

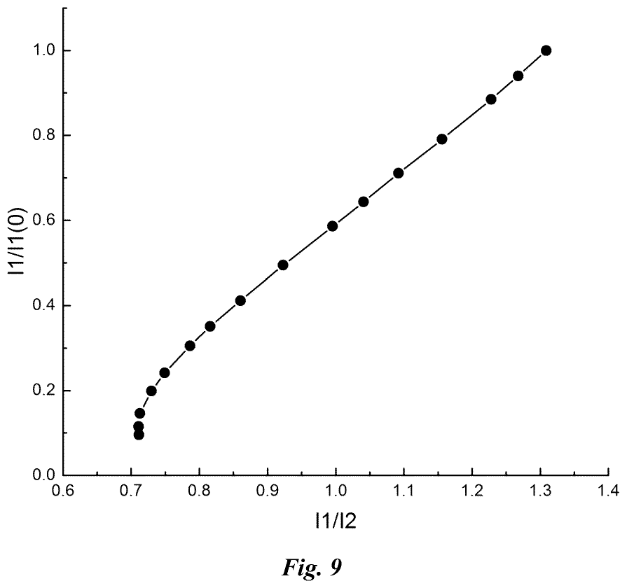

From an estimation of the particle size effect, a correction regime can be determined, such as in a graph (see FIG. 9). The y-axis of FIG. 9 plots the particle size effect measured with E1 (I1) relative to the fluorescence counts per second from an equivalent sample with no particle size effects (I1 (0)). In other words, normalised against a homogenous sample with an identical composition to the samples with particle size effects. The relative particle size effect is thus plotted against the ratio of I1 and I2.

A chart such as FIG. 9 may be thus used to determine a particle size effect. The plot of I1/I1 (0) against I1/I2 can be estimated using a Monte Carlo simulation, for example, and a general idea of the composition to be sampled. The sample can be measured using E1 and E2, and the resulting XRF spectra can be used to determine I1, I2 and the ratio I1/I2 calculated. I1 can thus be corrected by dividing with the corresponding I1/I1 (0) value (which may be used as a correction factor), removing the particle size effect.

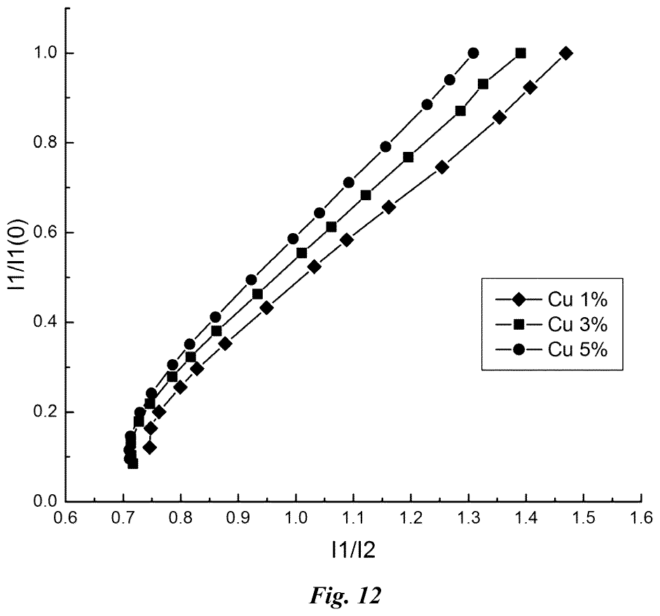

For samples with unknown concentrations and ranges, a figure can be constructing with a range of concentrations, for example, FIG. 12 shows predicted particle size correction trends for 3 different slurries, consisting of silica and water and varying copper content from 1-5%. Exciting each sample at radiation energies E1 and E2 will result in response fluorescence intensities I1 and I2, respectively, which have some particle size effect. Further, a fluorescence intensity with no particle size effects (I1 (0)) is collected by exciting a sample with no particle size effects with incident radiation energy E1. A sample with no particle size effects may be, but not limited to, a homogeneous equivalent sample. Such data can then be used to determine an approximate range for the particle size correction from a silica matrix slurry with an unknown copper concentration for example. For example, if an unknown sample is measured using this method, and returns the copper fluorescence values I1=480 c/s and I2=460 c/s, then I1/I2=1.04.

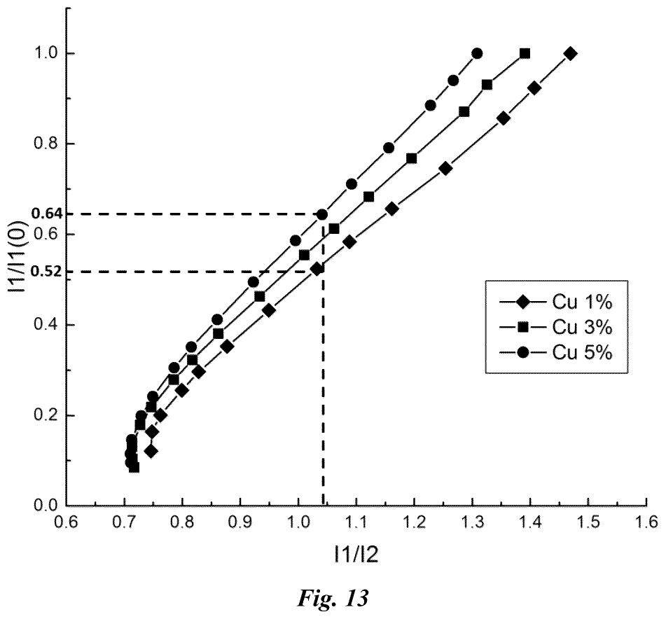

FIG. 13 shows an example of how a graph of I1/I1 (0) vs I1/I2, such as that shown in FIG. 12, can be used as a correction figure to determine the I1/I1 (0) value for a particular I1/I2 value such as 1.04. As shown on FIG. 13, for I1/I2=1.04, the corresponding range of I1/I1 (0) is 0.52-0.64. An average correction value of 0.58 can be used as a correction factor and the original value of I1 may be corrected to I1/(I1/I1 (0))=480/0.58=828 c/s.

In some forms, a processor of the XRF system may utilise one or more look-up tables, and/or one or more transfer functions to apply a correction factor. For instance, a first-order linear equation in a form of y=mx+b may be used as a transfer function, where x is I1/I2, and m and b are constants.

Utilisation of a plurality of incident energies (e.g. energy levels) allows for responsive adjustments and characterisation of a sample in question. Where different samples of different particle distributions are used, embodiments according to the present disclosure may provide a more adaptable XRF system. For instance, the present disclosure contemplates a system wherein small changes (e.g. in filters) can be quickly made in the XRF system to adapt to different characteristics of the sample. These aspects may be applicable for instance in a portable XRF system, where variations in sample particle size distribution may be higher than in controlled environments, while portability of systems and/or components may be limited.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. An X-ray fluorescence system comprising:
an X-ray source adapted to emit X-ray radiation that is incident on a sample;
a controller associated with the X-ray source, the controller adapted to vary an energy of the X-ray radiation that is incident on the sample between at least a first incident radiation energy and a second incident radiation energy, the second incident radiation energy being higher than the first incident radiation energy; and
an X-ray fluorescence detector to detect X-ray radiation fluoresced by the sample in response to the X-ray radiation that is incident on the sample and determine at least:
a first fluorescence radiation intensity of X-ray radiation fluoresced by the sample in response to the X-ray radiation incident on the sample at the first incident energy; and
a second fluorescence radiation intensity of X-ray fluorescence radiation fluoresced by the sample in response to the X-ray radiation incident on the sample at the second incident energy; and
a processor to determine a particle size correction factor based on the first fluorescence radiation intensity and the second fluorescence radiation intensity.

2. The system of claim 1, wherein the processor is adapted to correct the first fluorescent radiation intensity and/or the second fluorescent radiation intensity based on the particle size correction factor and determine a material composition of the sample based on the corrected first fluorescence radiation intensity and/or the corrected second fluorescence radiation intensity.

3. The system of claim 1, wherein the processor is adapted to determine a particle size correction factor based on the difference between the first fluorescence radiation intensity and the second fluorescence radiation intensity or a ratio of the first fluorescence radiation intensity to the second fluorescence radiation intensity.

4. The system of claim 3, wherein the processor is adapted to determine a material composition of the sample based on a corrected fluorescence radiation intensity of X-ray fluorescence radiation detected by the X-ray fluorescence detector, the corrected fluorescence radiation intensity being corrected based on the particle size correction factor.

5. The system of claim 4, wherein the processor is adapted to determine a material composition of the sample based on the first fluorescence radiation intensity as corrected based on the particle size correction factor, or based on the second fluorescence radiation intensity as corrected based on the particle size correction factor.

6. (canceled)

7. The system of claim 1, wherein the X-ray source has an X-ray emission end and the system comprises one or more filters selectively positionable by the controller between the X-ray emission end and the sample.

8. The system of claim 7, wherein the one or more filters comprise a first filter and a second filter and the controller is adapted to selectively position:
the first filter between the X-ray emission end and the sample to cause the energy of the X-ray radiation incident on the sample to be at the first incident radiation energy; and
the second filter between the X-ray emission end and the sample to cause the energy of the X-ray radiation incident on the sample to be at the second incident radiation energy.

9. The system of claim 8, wherein the first filter comprises a first filter material and the second filter comprises a second filter material that is different from the first filter material, or wherein the first filter has a first thickness and the second filter has a second thickness that is different from the first thickness.

10. (canceled)

11. The system of claim 7, wherein the one or more filters comprises a first filter and the controller is adapted to selectively position:
the first filter between the X-ray emission end and the sample to cause the energy of the X-ray radiation incident on the sample to be at the first incident radiation energy; and
no filter or a null filter between the X-ray emission end and the sample to cause the energy of the X-ray radiation incident on the sample to be at the second incident radiation energy.

12. The system of claims claim 1 further comprising a mechanism connected to the controller, the mechanism being for moving and selectively positioning the one or more filters between the X-ray emission end and the sample.

13. The system of claim 12, wherein the mechanism rotates the one or more filters for selectively positioning between the X-ray emission end and the sample, or wherein the mechanism slides the one or more filters for selective positioning between the X-ray emission end and the sample.

14 and 15 (canceled)

16. The system of claim 1, wherein the controller is adapted to control a power supply of the X-ray source to vary the energy of the X-ray radiation between the first incident radiation energy and the second incident radiation energy.

17. The system of claim 1, wherein the controller is adapted to control a voltage or current of the X-ray source to vary the energy of the X-ray radiation between the first incident radiation energy and the second incident radiation energy.

18. The system of claims claim 1, wherein the first and second incident radiation energies of the X-ray radiation incident on the sample are selected such that the first fluorescence radiation intensity is more susceptible to variation due to different sizes of the particles in the sample than the second fluorescence radiation intensity.

19. (canceled)

20. The system of claim 1, wherein the second incident radiation energy is between 2.5 to 3.5 times higher than the first incident radiation energy.

21 and 22 (canceled)

23. The system of claim 1, wherein the system is configured to determine an optimum incident radiation energy based on a ratio of the fluorescence radiation mass attenuation coefficient (μ(Εfluorescence)) to the incident radiation energy mass attenuation coefficient (μ(Εexciting)), and to use the determined optimum incident radiation energy to determine the first incident radiation energy and/or the second incident radiation energy.

24. (canceled)

25. A method comprising:
emitting X-ray radiation from an X-ray source such that it is incident on a sample containing particles of different sizes;
varying an energy of the X-ray radiation that is incident on the sample between at least a first incident radiation energy and a second incident radiation energy, the second incident radiation energy being higher than the first incident radiation energy; and
detecting at least a first fluorescence radiation intensity of X-ray radiation fluoresced by the sample in response to X-ray radiation incident on the sample at the first incident radiation energy, and a second fluorescence radiation intensity of X-ray fluorescence radiation fluoresced by the sample in response to X-ray radiation incident on the sample at the second incident radiation energy; and
determining a particle size correction factor based on the first fluorescence radiation intensity and the second fluorescence radiation intensity.

26. The method of claim 25 further comprising determining a material composition of the sample based on the first fluorescence radiation intensity and the second fluorescence radiation intensity.

claims 27-29 (canceled)

30. The method of claim 25 further comprising selectively positioning one or more filters between an X-ray emission end of the X-ray source and the sample to vary the incident radiation energy of the X-ray radiation that is incident on the sample.

31-36 (canceled)

37. The method of claim 25 further comprising selecting the first and second incident radiation energies of the X-ray radiation incident on the sample such that the first fluorescence radiation intensity is more susceptible to variation due to different sizes of the particles in the sample than the second fluorescence radiation intensity.

38-40 (canceled)
